(19) United States
(12) Patent Application Publication
(10) Pub. No.: US 2013/0225267 A1
(43) Pub. Date: Aug. 29, 2013

(54) MASSIVELY MULTIPLAYER GAME PROVIDING ONLINE SOCIAL INFLUENCE

(71) Applicants: Alan KOCH, Los Angeles, CA (US); Robert Miles Kemp, Los Angeles, CA (US); Andre Nitze, Berlin (DE)

(72) Inventors: Alan KOCH, Los Angeles, CA (US); Robert Miles Kemp, Los Angeles, CA (US); Andre Nitze, Berlin (DE)

(73) Assignee: Fun Built, LLC.

(21) Appl. No.: 13/440,969

(22) Filed: Apr. 5, 2012

Related U.S. Application Data
(60) Provisional application No. 61/603,114, filed on Feb. 24, 2012.

(51) Int. Cl. A63F 9/24; A63F 13/12

(52) U.S. Cl. 463/25; 463/42

(57) ABSTRACT

A massively multiplayer online game allowing players to use their influence to affect outcomes of the game. A method in the massively multiplayer online game comprises providing currency to a plurality of players for an online game having a duration; receiving spending information from a first player of the plurality of players, wherein the spending information affects an influence amount of a second player of the plurality of players; and updating a stored influence amount of the second player based on the received spending information, wherein, at the end of the duration, a stored influence amount of the second player is evaluated to determine whether the second player has one of the top stored influence amounts, and wherein the players amongst the plurality of players having the top stored influence amounts compete to potentially win a prize.

### BENEFIT OF PRIORITY

This application claims the benefit of U.S. Provisional Application No. 61/603,114, filed Feb. 24, 2012, which is incorporated herein by reference.

### BACKGROUND

The rise of social networking on websites such as Facebook™ has led to a proliferation of online games. In these games, players interact online, the interaction existing primarily in the form of visual images and icons displayed on electronic devices.

Some of these games involve users seeking to accumulate votes or points to win prizes in the games. Most of these games and their outcomes, however, reside within a virtual world. In particular, the games may not offer players the ability to influence real-world outcomes that are tied to the games as the games are being played.

### BRIEF DESCRIPTION OF THE DRAWINGS

FIG. 1 illustrates an exemplary system that includes a massively multiplayer online game in accordance with some embodiments.

FIG. 2 is a flow chart illustrating an exemplary sequence of rounds for online game of FIG. 1 in accordance with some embodiments.

FIG. 3 illustrates an exemplary window for joining Accruing Round of online game in accordance with some embodiments.

FIG. 4 illustrates an exemplary window in Accruing Round of online game in accordance with some embodiments.

FIG. 5 illustrates an exemplary window during Accruing Round of online game in accordance with some embodiments.

FIGS. 6A and 6B illustrate exemplary windows during Accruing Round of online game in accordance with some embodiments.

FIG. 7 illustrates an exemplary window during Accruing Round of online game in accordance with some embodiments.

FIG. 8 illustrates an exemplary window during Accruing Round of online game in accordance with some embodiments.

FIG. 9 illustrates an exemplary window during Finalist Round of online game in accordance with some embodiments.

FIG. 10 illustrates an exemplary window during Finalist Round of online game in accordance with some embodiments.

FIG. 11 illustrates an exemplary window during Impact Round of online game in accordance with some embodiments.

FIG. 12 is a flow chart illustrating an exemplary method for Accruing Round of online game in accordance with some embodiments.

FIG. 13 is a flow chart illustrating an exemplary method for Finalist Round of online game in accordance with some embodiments.

FIG. 14 is a flow chart illustrating an exemplary method for Impact Round of online game in accordance with some embodiments.

FIG. 15 is a flow chart illustrating an exemplary sequence of games for online game of FIG. 1.

### DETAILED DESCRIPTION

Reference will now be made in detail to the exemplary embodiments illustrated in the accompanying drawings. Wherever possible, the same reference numbers will be used throughout the drawings to refer to the same or like parts.

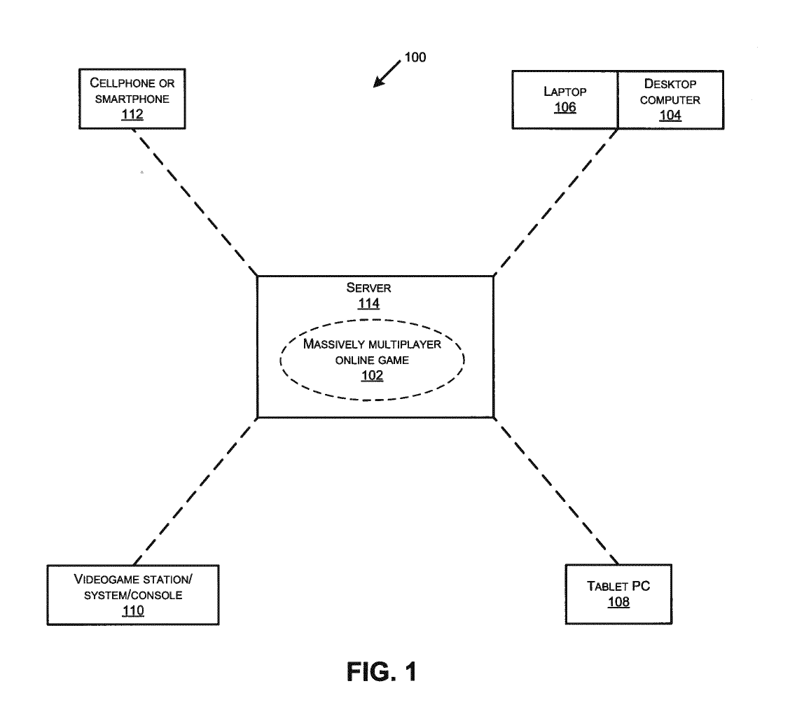

FIG. 1 illustrates an exemplary system 100 that includes one or more servers 114 providing a massively multiplayer online game 102 in accordance with some embodiments. As shown in FIG. 1, massively multiplayer online game 102 can be hosted on one or more servers 114, and played on any number of computing devices, examples of which include desktop computer 104, laptop or notebook computer 106, tablet PC 108, video game station/system/console 110, and cell phone or smartphone 112. The computing devices include any other media content player, for example, a set-top box, a television set, or any electronic device capable of providing or rendering data. In addition, online game 102 can be played across any number of different computing devices.

Server 114, which provides online game 102, can include a web server, an enterprise server, or any other type of computer server, and can be computer programmed to accept requests (e.g., HTTP, or other protocols that can initiate data transmission) from a computing device and to serve the computing device with requested data. In addition, server 114 can be a broadcasting facility, such as free-to-air, cable, satellite, and other broadcasting facility, for distributing data.

Server 114 can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

In some embodiments, online game 102 can be provided as a software application that is downloaded onto the computing devices from server 114 and that allows the computing devices to connect to server 114. For example, online game 102 can be provided through an internet website that is hosted by server 114. In other embodiments, online game 102 can be provided on a media source which is readable by one or more of the computing devices. The media source can be any type of storage medium capable of storing electronic data. The media source can, for example, be provided as a CD, DVD, Blu-ray disc, hard disk, magnetic tape, flash memory card/drive, volatile or non-volatile memory, holographic data storage, and any other type of storage medium. Online game 102 can be stored on the media source, and downloaded onto the computing devices via the media source. In some embodiments, online game 102 can be activated and played when the computing device connects to a network.

The computing devices can include software applications that allow the computing devices to communicate with and receive data from a network or local storage medium. Each of the computing devices is operatively connected to one another via a network or any type of communication links that allow transmission of data from one component to another. The network can include Local Area Networks (LANs) and/or Wide Area Networks (WANs), and can be wireless, wired, or a combination thereof. The network can extend onto the Internet, or it can be a peer-to-peer network. The network can also include data networks such as a cloud computing network.

Although particular computing devices are illustrated and networks described, it is to be appreciated and understood that other computing devices and networks can be utilized without departing from the spirit and scope of the embodiments described herein.

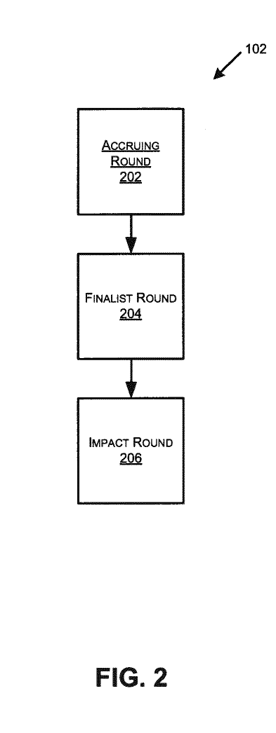

FIG. 2 is a flow chart illustrating an exemplary sequence of rounds for online game 102 of FIG. 1. In this example, online game 102 can provide three rounds of game play: Accruing Round 202, Finalist Round 204, and Impact Round 206. Online game 102 provides a grand prize to a winner, and the grand prize can come in the form of a cash prize. Examples of players' objectives when playing online game 102 include attempts to win the grand prize, or aiding other players in winning the grand prize. Each round of game play is described in further detail with reference to the figures as follows.

Accruing Round

In some embodiments, online game 102 starts with Accruing Round 202.

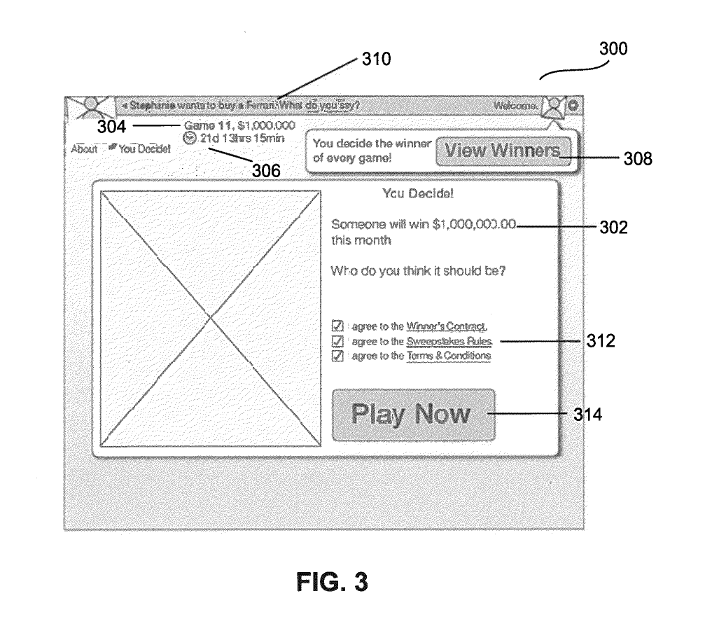

FIG. 3 illustrates an exemplary window 300 of Accruing Round 202 in accordance with some embodiments. In particular, window 300 can allow players to join online game 102 and participate in Accruing Round 202. As stated previously, the players can include any users of the different computing devices shown in FIG. 1, such as, users from social networking websites, such as Facebook™, Twitter™, etc.

In some embodiment, the grand prize of online game 102 is indicated in a message. For example, message 302 in FIG. 3 states “Someone will win $1,000,000.00 this month.” This can mean that a player has the ability to win a grand prize in an amount of $1,000,000 at the end of online game 102, in the current month in which online game 102 is being played. It is noted that the grand prize can be a cash prize in any amount and real dollar denomination of any currency, as stipulated by organizers of online game 102. As stated previously, a player can attempt to win the grand prize, or help other players to win the grand prize.

In some embodiments, online game 102 can comprise a series of games. For example, message 304 in window 300 of FIG. 3 shows “Game 11”. In other words, the game that is played in the example of FIG. 3 is the eleventh game of online game 102. In some embodiments, the series of games can be sequential or staggered, with a next game beginning after a previous game has ended. In yet other embodiments, the series of games can be played concurrently.

Accruing Round 202 can have a time duration. As shown in FIG. 3, message 306 displays the length of time before Accruing Round 202 of Game 11 of online game 102 ends. In this example, message 306 indicates that Accruing Round 202 ends in 21 days, 13 hours, and 15 minutes. In some embodiments, the duration can be predetermined. In other embodiments, the duration can be dynamic, allowing, for example, Accruing Round 202 to end upon online game 102 reaching a certain revenue target.

In some embodiments, link 308 is provided in window 300, whereby a player can view information relating to winners of previous games. For example, by clicking on link 308, a player can view the past winners of Game 1 through Game 10 preceding the current Game 11.

In some embodiments, window 300 can display messages posted by players. For example, players may post messages stating their preferences for spending the grand prize if they win the grand prize. In the example of FIG. 3, message 310 shows a message posted by a player “Stephanie,” who has indicated she wants to buy a Ferrari (if she wins the Grand Prize). Message 310 further includes a question “What do you say?”.

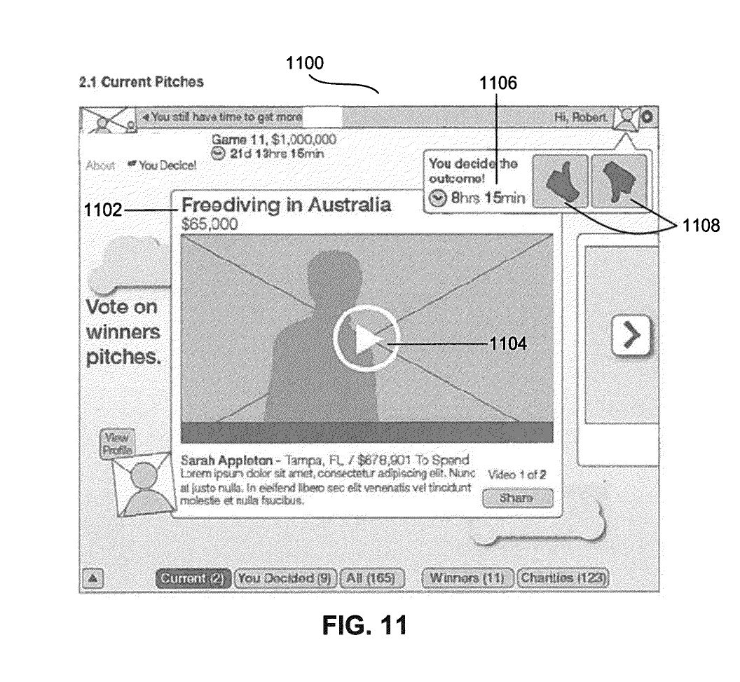

In some other embodiments, message 310 can display the proposal(s) of a winner of a Finalist Round 204 from another game. For example, online game 102 can author and announce the winner's proposal(s) during an Impact Round 206 of another game that is being played concurrently with Game 11. As shown in message 310 in FIG. 3, “Stephanie” may be the winner of a Finalist Round 204 from another game, and her proposal in an Impact Round 206 is to purchase a Ferrari with the Grand Prize. In some embodiments, message 310 can provide a link to a voting window. For example, selecting message 310 can lead a player to the exemplary window of FIG. 11, in which players can vote for the winner's proposal.

As stated previously, players can aid another player to win the grand prize. In this case, friends, family members, or supporters of the player Stephanie can join Accruing Round 202 to help Stephanie win the grand prize.

Window 300 can also comprise checkboxes whereby players agree to the rules and conditions of online game 102 before joining Accruing Round 202. For example, the rules and conditions can include terms contained in a winner's contract, sweepstakes rules, and other terms and conditions. A player agrees to the terms and conditions by selecting checkboxes 312 in window 300. As shown in FIG. 3, link 314 (“Play Now”) is provided in window 300. Online game 102 allows a player to join Accruing Round 202, upon the player selecting checkboxes 312 and link 314.

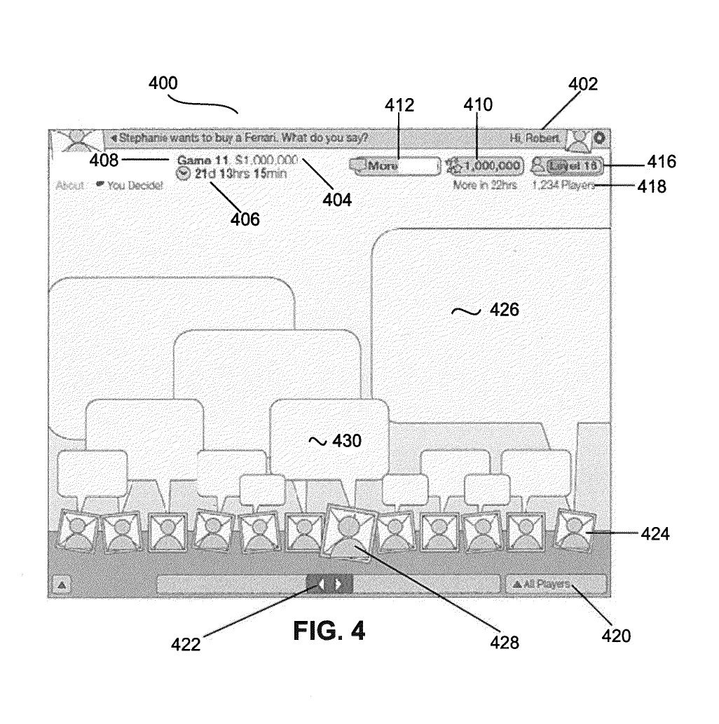

After the player has successfully joined Accruing Round 202, online game 102 can provide a greeting message to the player. As shown in exemplary window 400 of FIG. 4, greeting message 402 displays “Hi, Robert” to the player Robert. Similar to FIG. 3, window 400 indicates the grand prize of $1,000,000 (404), length of time before Accruing Round 202 ends (406), and that the current game being played is “Game 11” (408).

In Accruing Round 202, each player receives an amount of game currency. The amount of game currency can be a fixed amount, an amount based on a number of contacts (such as friends in Facebook™, etc.), or an amount based on previous game play.

Online game 102 can display the amount of game currency that a player has. For example, message 410 in FIG. 4 indicates that Robert has a game currency amount of 1,000,000. This can be an amount provided by online game 102 for Accruing Round 202. This amount can also be fixed for all players.

In some embodiments, the amount of game currency provided by online game 102 to Robert can be based on the number of contacts that Robert has, for example, Robert's number of friends in Facebook™. For example, online game 102 can provide an amount of game currency to Robert that is proportional to the number of contacts that Robert has, relative to the number of contacts that other players have.

The amount of game currency provided by online game 102 to Robert can also be based on Robert's previous game play. For example, if Robert has played in a number of games before current Game 11 and has game currency remaining from those games, online game 102 can allow Robert to carry over the remaining game currency into Game 11. In some embodiments, the amount of game currency can be based on Robert's selections of winners from previous games.

As stated previously, one of the players' objectives during Accruing Round 202 is to strategically use game currency to garner the greatest amount of influence from other players. At the end of Accruing Round 202, a number of players with the greatest amounts of influence can continue to Finalist Round 204 for a chance to win the Grand Prize.

As shown in FIG. 4, window 400 provides a link 420 (“All Players”) which allows a player to view all the other players in Accruing Round 202. In the example of FIG. 4, message 418 shows there are 1,234 players in Game 11 of online game 102. In some embodiments, the number of players can comprise the number of players who are playing the game real-time (for example, all players who are logged on to the internet and actively playing the game at that instant). In other embodiments, the online game 102 displays the total number of players who have joined the game, regardless of whether there are players who are not actively playing the game at that instant. In some other embodiments, the online game 102 displays all the players within a player's local game. In some further embodiments, the online game 102 displays all the players at a global level, comprising players in all local games that are being played concurrently.

In some embodiments, link 420 can provide a filter selectively displaying different groups of players based on the player's selection. The different groups of players can include, for example, a player's friends on Facebook™, players who have spent currency on the player (e.g. the players who have spent currency on Robert), players whom a player has spent currency on (e.g. the players whom Robert has spent currency on), etc.

In the example of FIG. 4, the player Robert, by selecting link 420, can view some or all the players in Accruing Round 202. As shown in window 400, each player can be displayed as an icon, with a speech balloon associated with the player. For example, icon 424 can correspond to the player Stephanie, with speech balloon 426 associated with Stephanie. Similarly, Robert can be represented by icon 428 with speech balloon 430. The icons 424 and 428 can comprise, for example, pictures, images, or video clips based on information received from their respective players. For example, icon 424 can comprise a photograph of Stephanie, and icon 428 can comprise a video clip of Robert.

As shown in FIG. 4, the icons and speech balloons associated with the players can be presented in a landscape view in window 400. FIG. 4 also shows arrow cursor 422 which allows a player to zoom in or out of the landscape view of the players. For example, Robert can use arrow cursor 422 to view the entire landscape of players, or select a subsection of the landscape comprising a smaller group of players.

The speech balloon associated with each player provides a visual display of the relative influence of each player. In other words, the players' influence are characterized by the sizes of their speech balloons. For example, the larger the speech balloon associated with a player, the greater the influence of the player. As shown in FIG. 4, Stephanie (represented by icon 424) has the largest speech balloon (426). Therefore Stephanie has the greatest influence among all the players shown in window 400.

A player can thus observe the influence of other players relative to the player's own influence during Accruing Round 202. In the example of FIG. 4, Robert can view the influence of the other players in window 400, and compare his influence to those of other players based on the sizes of the speech balloons. Besides indicating how great each player's influence, speech balloons can also show various types of content posted by players. For example, the speech balloons can show posted comments from the players.

In some embodiments, online game 102 can display the level that a player is at. As shown in FIG. 4, message 416 displays the player's level (in this example, Robert is at Level 16 in Game 11 of online game 102). In some embodiments, the player's level can correspond to the influence of the player. For example, a player with more influence is rated at a higher level than a player with less influence. In other embodiments, the player's level can be based on the number of games the player has played, the amount of playing time the player has logged, or the amount of influence or currency the player has accumulated over all games. For example, a player who has played more games can be at a higher level compared to a player who has played fewer games. Similarly, a player who has logged more playing time can be at a higher level than a player who has logged less playing time.

In some embodiments, message 416 displays a player's level based on the player's lifetime record of spending currency. For example, a player who has spent more currency in the games that he or she has played is at a higher level than another player who has spent less currency.

In some embodiments, a player's level does not reset when a new game is started. In other embodiments, a player's level as shown in message 416 resets when a new game is started. In some other embodiments, online game 102 can provide events during a game that increase a player's level, for example, as an incentive to play the game.

During Accruing Round 202, a player can spend his or her game currency to increase one or more other players' influence. As stated previously, one of the players' objectives during Accruing Round 202 is to strategically use game currency to garner the greatest amount of influence from other players. In other words, value from the currency, in the form of influence, is derived when the player spends the currency to increase another player's influence.

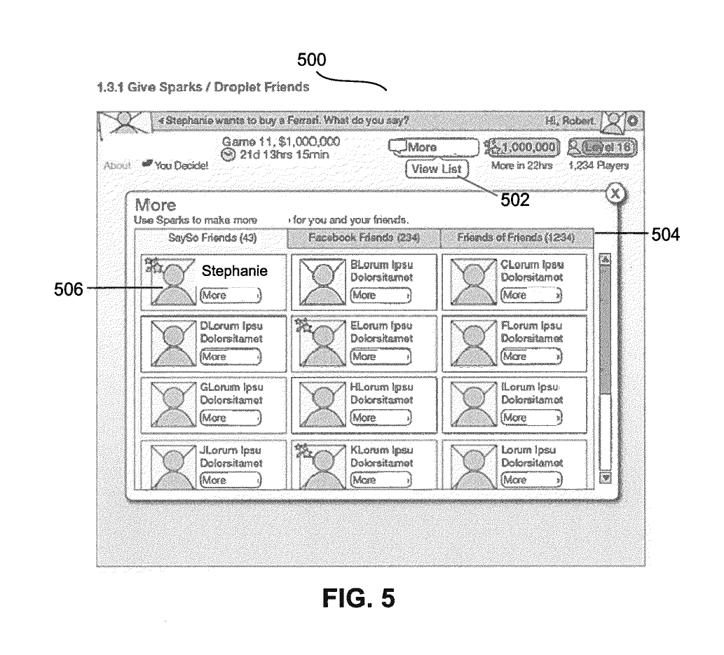

In the example of FIG. 4, Robert may want to spend currency on Stephanie to increase Stephanie's influence. In some embodiments, Robert can do so by first selecting icon 412, which produces window 500 of FIG. 5, which illustrates an exemplary window during Accruing Round 202 of online game 102. Next, Robert can select icon 502 (“View List”), which provides contact list 504. Contact list 504 can, for example, comprise a list of players in Robert's contact list, such as friends, family members, etc. Robert can then scroll through contact list 504 to search for Stephanie. Alternatively, if Stephanie is not in contact list 504, Robert can “add” her to contact list 504. In the example of FIG. 5, Stephanie is represented by icon 506. Robert can spend currency on Stephanie to increase her influence by selecting icon 506 and designating an amount of currency to be spent on Stephanie. In addition, Robert can select other players in contact list 504 whom Robert wants to spend currency on to increase their influence.

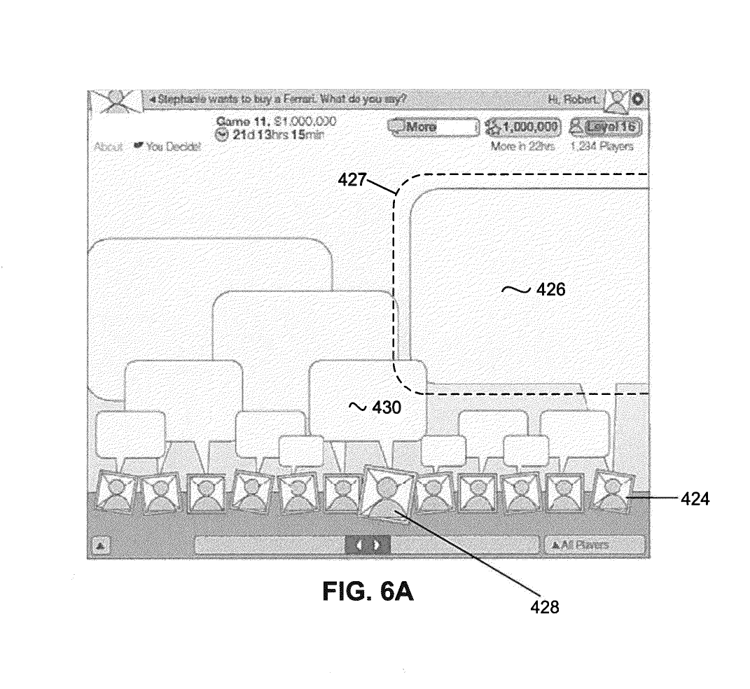

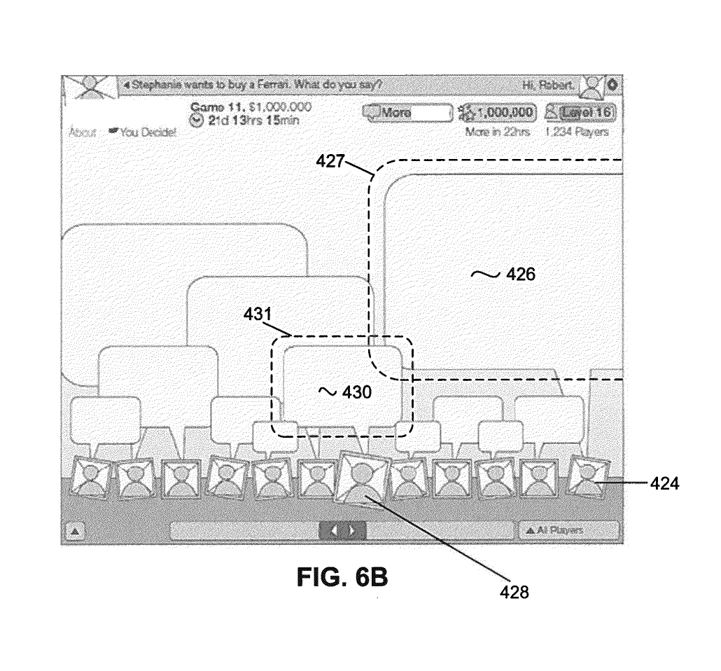

In other embodiments, Robert can spend currency on Stephanie by selecting icon 424 in window 400 of FIG. 4 and designating an amount of currency to be spent on Stephanie. Stephanie's influence increases when Robert or any other player spends currency on her. The increase in Stephanie's influence can be characterized by an increase in size of speech balloon 426 associated with Stephanie to a larger speech balloon 427 (illustrated by the dashed line), as shown in FIG. 6A.

In some embodiments, when a player spends currency to increase another player's influence during Accruing Round 202, the spending player's own influence also increases by an amount. For example, when Robert spends currency on Stephanie or other players, his own influence also increases by an amount. This is illustrated by an increase in size of speech balloon 430 associated with Robert to a larger speech balloon 531 (illustrated by the dashed line), as shown in FIG. 6B. In some embodiments, when a player spends game currency to increase another player's influence, both players' influence increase by an amount, which can be equal for both players. This amount of increase can also be tied to the amount of currency transferred between the players.

Similarly, Stephanie can, in reciprocation, spend currency on Robert to increase Robert's influence. In some embodiments, Stephanie's spending of currency on Robert will also increase Stephanie's own influence, which further increases the sizes of both Stephanie's and Robert's speech balloons, similar to the examples shown in FIGS. 6A & 6B.

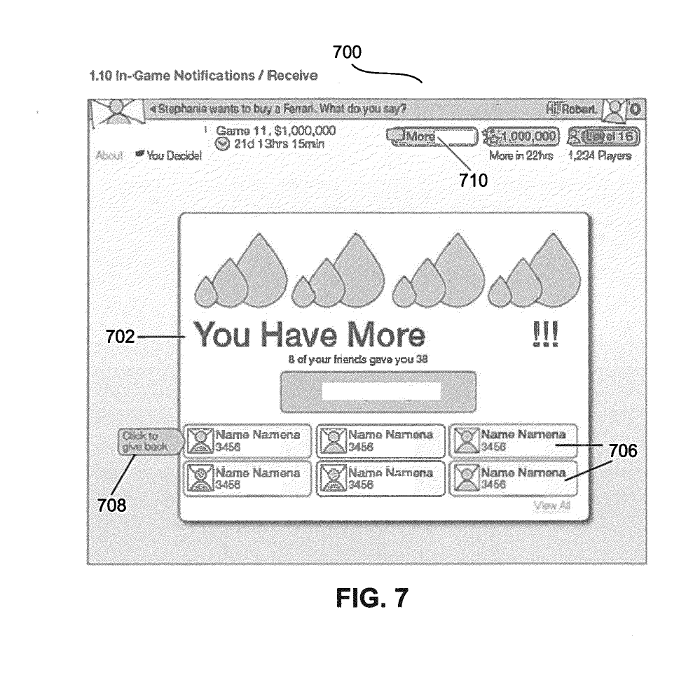

When Stephanie and other players spends currency on Robert, a message 702 is provided in window 700 of FIG. 7 notifying Robert “You Have More !!!”. As shown in FIG. 7, message 702 notifies Robert that some of his friends have increased his influence by spending currency on him (in this example, eight players have given Robert a total amount of 38 influence points, which could correspond to his friends spending a total of 38 currency on Robert).

As stated previously, in some embodiments, a player's influence increases when the player spends currency to increase other players' influence. In the example of FIG. 7, list 706 is provided, comprising players who have given influence or spent currency on Robert. Robert can select link 708 (“Click to give back”) to spend/give an amount of currency to one or more players in reciprocation. In some embodiments, Robert's influence increases by an amount proportional to the amount of currency he spends on the one or more players.

In yet further embodiments, players may not spend game currency to increase their own influence during Accruing Round 202, except by spending game currency to increase another player's influence. For example, neither Robert, Stephanie, nor any player in Accruing Round 202 can spend currency on themselves to increase his or her own influence.

While the ways for increasing a player's influence during Accruing Round 202 have been explained in detail above, it will be appreciated that others means can be used for increasing the player's influence during Accruing Round 202. For example, if a player recommends and obtains more of his or her contacts to join online game 102, the player can be rewarded with more influence.

During Accruing Round 202, currency can be purchased in-game in order to augment the game currency that is provided when the player first joins the game. For example, a player may want to replenish game currency when game currency has been depleted (e.g. when the player has spent all of his or her game currency on other players).

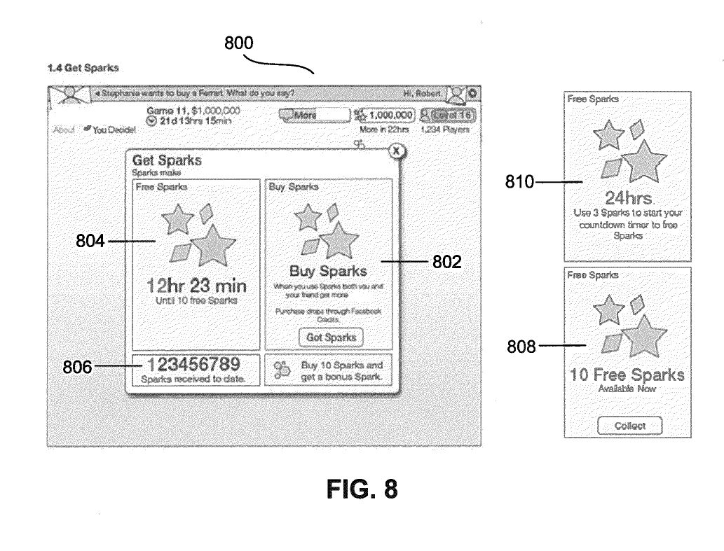

For example, when Robert wishes to replenish game currency, Robert can select link 710 (“More”) in window 700 of FIG. 7 to purchase game currency. This can produce exemplary window 800 of FIG. 8. As shown in FIG. 8, Robert can select link 802 to purchase game currency. In the example of FIG. 8, the game currency is called “Sparks.”

A player can spend purchased currency on other players to increase the other players' influence. In some embodiments, this also increases the spending player's own influence. In some further embodiments, players can also be rewarded with additional game currency during the game by subscribing to an online service, by registering for a credit card or a promotion, by getting more contacts to play the game, or by any other means.

In some embodiments, online game 102 can provide free currency at certain time intervals during Accruing Round 202, so as to incentivize players to continue playing in Accruing Round 202. For example, as shown in FIG. 8, a message 804 is displayed indicating that 10 free currency (“Sparks”) will be given to Robert in another 12 hours and 23 minutes from the instant shown in window 800. After the 10 free currency (“Sparks”) becomes available, message 808 can be displayed in window 800 to notify Robert that the free game currency is available for collection.

Window 800 can also include message 806 displaying the amount of currency that Robert has received to date (“123456789 Sparks”), either through purchase of game currency or other players spending game currency on Robert. In some embodiments, message 810 allows Robert to spend currency to start a timer that begins counting down to the next collection of free currency.

In some embodiments, use of game currency in the current game (e.g. Game 11) can help a player in a future game (e.g. Game 13). For example, a player can arrange with another player to give some or all of the game currency of the giving player to the receiving player, in exchange for the receiving player's promise to reciprocate in a future game.

At the end of Accruing Round 202, the three players with the most influence are designated as Finalists to enter into Finalist Round 204. While three Finalists are described in the embodiments herein, it is appreciated that any number of Finalists can be designated.

Finalist Round

In Finalist Round 204, Finalists from Accruing Round 202 compete to become the Winner of Finalist Round 204. The Finalist with the most influence at the end of Finalist Round 204 is designated the Winner of a Grand Prize, which can include a right to spend a cash prize. The remaining players from Accruing Round 202 join Finalist Round 204 as the Crowd.

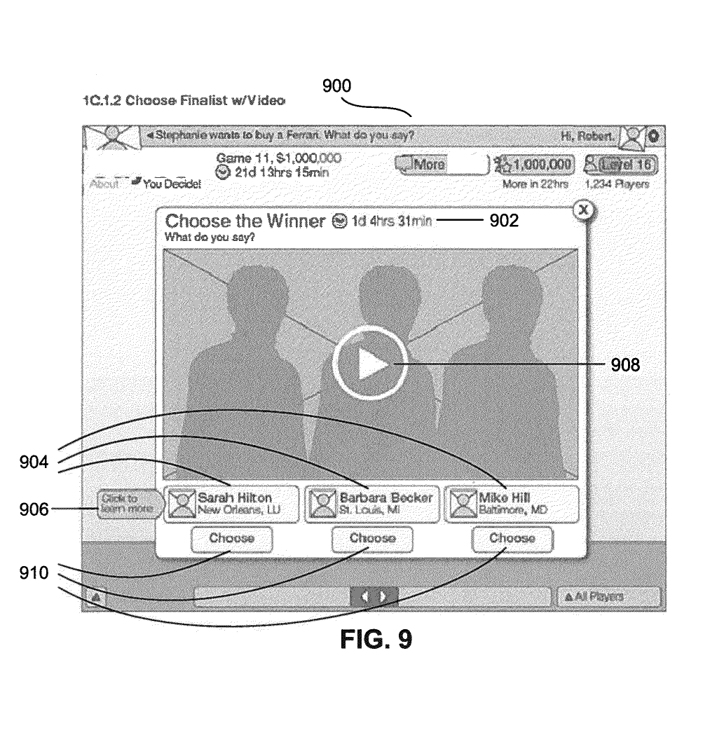

Finalist Round 204 can have a time duration. For example, message 902 in window 900 of FIG. 9 shows that Finalist Round 204 of Game 11 of online game 102 ends in 1 day, 4 hours, and 31 minutes. In some embodiments, the time duration of Finalist Round 204 can be predetermined. In other embodiments, the time duration of Finalist Round 204 can be dynamic, allowing, for example, Finalist Round 204 to end upon reaching a certain revenue target.

As shown in FIG. 9, Finalists are represented by icons 904. Each icon can include the name of a Finalist, and city where the Finalist is from. In addition, each icon can include a picture or image, for example, a photograph of the Finalist. After a player moves a mouse cursor over an icon 904, message 906 (“Click to learn more”) can be displayed adjacent to the icon 904 associated with the Finalist. By selecting message 906, a player can learn more information relating to the Finalist. In some embodiments, selecting message 906 corresponding to a Finalist provides play button 908. Play button 908 can be further linked to a video associated with the Finalist or all Finalists. For example, the video can allow a Finalist to plead to the Crowd on why the Crowd should vote for them. Voting buttons 910 (“Choose”) are provided below the icons 904 for each Finalist. Each player in the Crowd can vote for a Finalist by selecting voting button 910 associated with the Finalist.

During Finalist Round 204, after a player has voted for a Finalist, the player can lend his or her influence to the Finalist in order to increase the Finalist's influence and chances of winning the Grand Prize. In some embodiments, the players can lend their influence which had been carried over from Accruing Round 202. For example, if a player has 3,000 influence from Accruing Round 202, the player can choose which Finalist the player wants to lend his or her influence to. In addition, the player may choose to lend some or all of his or her influence to a Finalist.

In some embodiments, a player's lending of influence to a Finalist does not deplete the influence of the lending player and would allow the player to give (or receive) influence to (or from) other players. The amount in which their influence increases during this time equally increases their “influence commitment” to the Finalist of their choice. In this way, even though a player cannot switch Finalists once aligned, they can still work to change the outcome of the Finalist Round.

In some embodiments, Finalists can have their influence equalized at the start of Finalist Round 204 before competing for the Grand Prize. In other embodiments, Finalists can maintain their level of influence from Accruing Round 202. In some further embodiments, Finalists are given a set amount of influence in Finalist Round 204 based on their performance in Accruing Round 202. For example, a Finalist having the most influence at the end of Accruing Round 202 receives the highest amount of influence (e.g., 5,000 influence points), while a Finalist having the least influence receives the lowest amount of influence (e.g., 4,000 influence points). As stated previously, each of the Finalists competes to obtain the influence from the Crowd. At the end of Finalist Round 204, the Finalist with the highest amount of influence is declared the Winner of the Grand Prize.

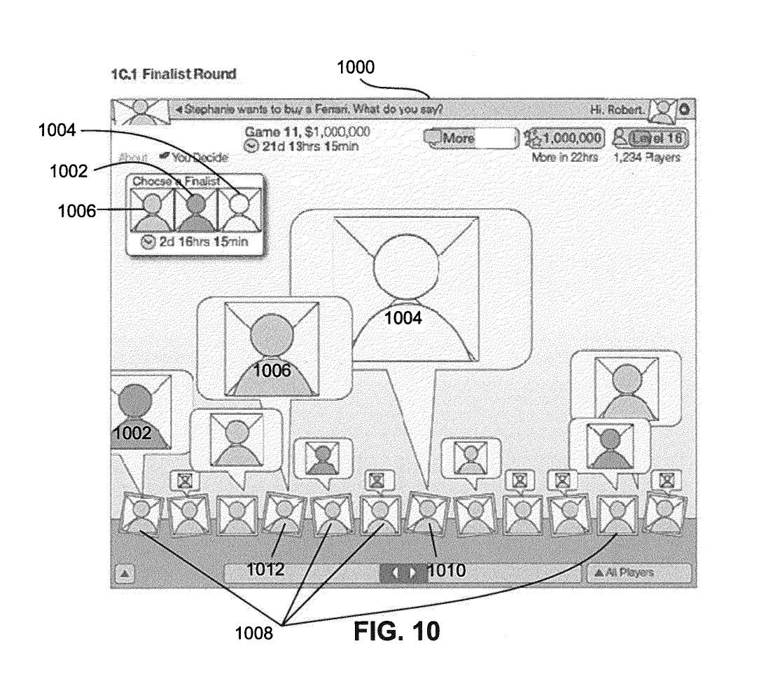

As shown in FIG. 10, a player can view which Finalist other players voted for. For example, window 1000 of FIG. 10 shows three icons representing Finalists 1002, 1004, and 1006, respectively. Window 1000 also shows the players in the Crowd and their respective speech balloons in a landscape view. In the example of FIG. 10, the players in the Crowd include players 1008 and player 1010. Players 1008 are aligned with Finalist 1002 whom they voted for, as shown by the icon of Finalist 1002 in the speech balloons of players 1008. After players 1008 are aligned with Finalist 1002, players 1008 can lend some or all of their influence to Finalist 1002. This increases the influence of Finalist 1002 by the composite of the influence lent by players 1008. Similarly, player 1010 is aligned to Finalist 1004, and player 1010 can lend some or all of his or her influence to Finalist 1004. In this case, player 1010 has the largest influence among the players in the Crowd shown in window 1000. Therefore, if player 1010 chooses to lend his or her influence to Finalist 1004, this can significantly increase the influence of Finalist 1004, which may increase the odds of Finalist 1004 winning Finalist Round 204.

During Finalist Round 204, a player can receive (or lend) influence to other players. In some embodiments, an increase in a player's influence during Finalist Round 204 leads to an equal increase in the influence that the player lent to a Finalist, which then increases the influence of the Finalist. As a result, in some embodiments, even though a player may not switch to another Finalist after the player has aligned with a particular Finalist, the player can still continue to affect the outcome of Finalist Round 204 by receiving (or lending) influence to other players. In the example of FIG. 10, player 1012 can lend his or her influence to player 1010. Thus, even though player 1012 may be aligned to Finalist 1006, player 1012 can still be indirectly aligned to Finalist 1004 when player 1012 lends his or her influence to player 1010. For example, if player 1010 lends some or all of the composite influence to Finalist 1004, the influence of player 1012 is thus indirectly lent to Finalist 1004. In this case, even though player 1012 is aligned with Finalist 1006, player 1012 can still continue to dynamically affect the outcome of Finalist Round 204 by either lending influence to (or receiving influence from) other players who are aligned with other Finalists.

In some embodiments, a player's selection of a Finalist can affect how much currency the player receives in a future game. For example, if the player selects the winning Finalist in the current game (e.g. Game 11) by giving the Finalist all of his or her influence, the player can receive an amount of game currency in a subsequent game (e.g. Game 13) corresponding to the amount of influence the player gave to the winning Finalist. For example, a player giving 1,000 influence to the winning Finalist in the current game could receive an additional 1,000 currency for a subsequent game. If, however, the player selects a losing Finalist, the player's game currency in a subsequent game may not be affected by the amount of influence the player had in the previous game.

In some other embodiments, the players can lend their influence to more than one Finalist. Here, instead of lending the influence to only one of three Finalists, the players can apportion their influence across two or three of the Finalists in order to “hedge” their selections. For example, a player having 4,000 influence can give 2,000 influence to Finalist #1, 1,000 influence to Finalist #2, and 1,000 influence to Finalist #3, so that the player does not have to start over in case he or she chooses a non-winning Finalist.

In some embodiments, the players' influence totals can be reset at the end of Finalist Round 204, although the players retain any remaining currency that was not spent during Accruing Round 202. The players can spend their remaining currency in another Accruing Round 202 of a future game. As described above, some players (selected based on their game-play histories) can be allowed to transform their influence into currency for a next Accruing Round 202.

At the end of Finalist Round 204, the Finalist with the most composited influence will be designated as the Winner. The Winner is then awarded a Grand Prize, which can be a large cash prize that the Winner can spend. In some embodiments, the Winner's right to spend the cash prize is subject to Crowd approval in Impact Round 206 of online game 102.

Impact Round

The final round of online game 102 (or for the online game depicted in FIG. 2) is Impact Round 206. An objective of Impact Round 206 is for the Crowd to use their influence to influence the Winner of Finalist Round 204 as he or she attempts to utilize the Grand Prize. In some embodiments, the Winner is allotted a prescribed amount of time in Impact Round 206 to gain Crowd approval to spend the Grand Prize. In some embodiments, the Winner is free to propose different ways to use the Grand Prize, but the Winner's proposals are subject to the approval of the Crowd. Within the prescribed amount of time, the players in the Crowd can choose to align their influence to approve each proposal by the Winner.

In some embodiments, the Winner can present one more proposals concurrently. The Crowd can vote to approve one or more of the proposals, or the Crowd may vote on none of the proposals. For example, the Crowd can vote to approve a first proposal, or vote to approve a second proposal, or choose not to vote for either proposal. Moreover, the Winner can present a number of proposals that can be assigned to brackets (similar to, for example, an NCAA™ bracket). For example, if the Winner identifies four different proposals (proposals A, B, C, D), the Crowd could choose the winning proposals of proposal A versus proposal B and of proposal C versus proposal D to move on to the next winning proposal round where the Crowd will determine which one of these two proposals is the approved proposal.

In some embodiments, a proposal can, for example, be in the form of a video posted by the Winner indicating how he or she wants to spend the Grand Prize. In some embodiments, each proposal is allotted an amount of time within a prescribed amount of time in order to help the Winner to determine whether the proposal will gain the support of the Crowd.

The example of FIG. 11 shows proposal 1102 in Impact Round 206, in which the Winner proposes to use part of the Grand Prize ($65,000) for “Freediving in Australia”. In window 1100 of FIG. 11, a play button 1104 is provided, which can be linked to a video posted by the Winner showcasing the Winner's proposal to freedive in Australia. The proposal 1102 can be allotted an amount of time for the players in the Crowd to determine if they support the proposal. For example, countdown timer 1106 is provided indicating the amount of time remaining (8 hrs 15 mins) for proposal 1102, during which the players in the Crowd can choose to align their influence to approve each proposal. As shown in FIG. 11, the players in the Crowd can approve proposal 1102 by selecting one of “thumbs-up” or “thumbs-down” icons at 1108.

In some embodiments, each player's influence from Finalist Round 204 is carried over into Impact Round 206. In these embodiments, the decision of each player to approve the proposal is weighted based on the player's influence. For example, after receiving an approval from a player, the amount of that player's influence is then aligned to proposal 1102. Likewise, after receiving a rejection from a player, the amount of that player's influence is then aligned against proposal 1102. In some other embodiments, instead of using influence to determine whether proposal 1102 passes, online game 102 can tally votes from players, wherein each player has a single vote. It is readily appreciated, however, that the votes can be weighted using means associated with previous rounds of online game 102, or weighted using other means.

In some embodiments, the weight of the players' votes for proposal 1102 is derived from the players' influence in a concurrent or subsequent round(s) of another game(s). For example, a player can participate in Accruing Round 202 of another game while the player is still in Impact Round 206 of a game. If the player's influence in Accruing Round 202 of the other game increases, this can lead to a corresponding increase in the weight of the player's vote for the Winner's proposal in Impact Round 206 of the game. Furthermore, if a player takes part in multiple concurrent Accruing Rounds 202 of other games, the player's aggregate increase in influence from those multiple concurrent Accruing Rounds 202 lends to a corresponding increase in the weight of the player's vote for the Winner's proposal in Impact Round 206 of a game. Therefore, in some embodiments, a player can affect the outcome of Impact Round 206 of a game by taking part in Accruing Rounds 204 of other games.

At the end of the allotted time for proposal 1102, online game 102 can determine whether proposal 1102 was approved. Online game 102 can tally whether the aligned influence outweighs the against influence. After the determination, online game 102 can announce to the Crowd the outcome of proposal 1102, based on the amount of influence aligned to proposal 1102. The Winner will then know whether his or her proposal has gained the approval of the Crowd. In some embodiments, approval of the Crowd is contingent upon proposal 1102 obtaining a majority of the Crowd's influence, which can be a number or percentage.

In some embodiments, if the Winner's proposal is rejected by the Crowd, the Winner can be given an opportunity to submit another proposal to the Crowd. Once again, the Crowd can choose to accept the new proposal within an allotted time.

At the end of Impact Round 206, if the Winner's proposal wins the Crowd's approval, the Winner can spend the Grand Prize in accordance with the approved proposal. Any unallocated or unspent portion of the Grand Prize is forfeited by the Winner. In some embodiments, the Winner's expenditures can be recorded by a film crew and can be viewed by the Crowd or anyone online.

If, however, the Winner does not obtain Crowd approval by the end of Impact Round 206, all portions of the Grand Prize can be forfeited.

Throughout the game, player activities can be supported by a combination of game graphics and user-generated, real-world video content. The game graphics can be used to graphically depict influence status across players, while user-generated content can be used to introduce the Finalists or communicate Winner's proposals and Grand Prize allocations in the real world.

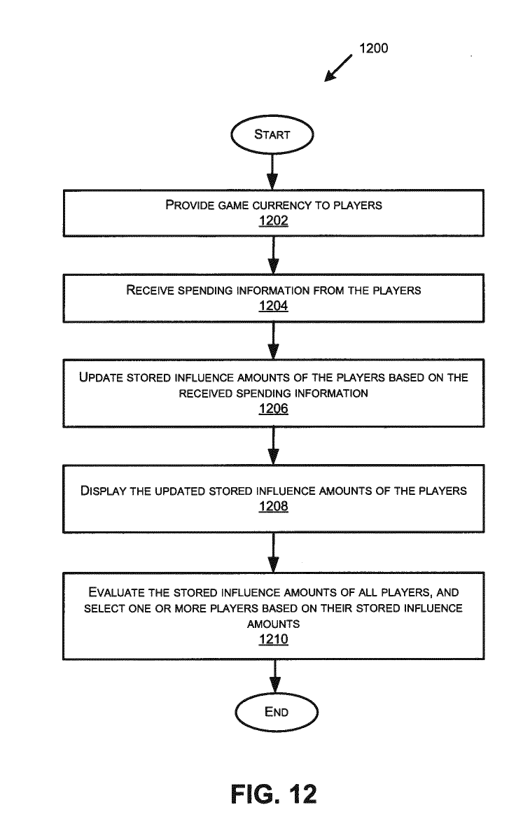

FIG. 12 is a flow chart illustrating an exemplary method 1200 for a round (e.g., Accruing Round 202) of an online game in accordance with some embodiments. It will be readily appreciated by one of ordinary skill in the art that the illustrated procedure can be altered to delete steps or further include additional steps.

Referring to FIG. 12, the online game provides game currency to the players when they participate in the round of online game (step 1202). The amount of game currency provided can be a fixed amount and/or an amount based on a number of contacts (such as friends in Facebook™, etc.) that a player has. The amount of game currency provided can also be an amount based on previous game play. For example, if a player has played in a number of previous games and has game currency remaining from those games, the online game provides the player an amount based on the remaining game currency in the round of the online game. In addition, the amount of game currency provided can be based on a player's selections of winners from previous games.

The online game can receive spending information from the players (step 1204), wherein the spending information affects an influence amount of the players. For example, as noted previously with reference to FIGS. 5 and 6A-B, a player can spend his or her currency on other players in order to increase the influence of the other players. In some embodiments, as further explained above, the spending of currency on other players can increase the influence on the spending player. In some other embodiments, when a player spends game currency to increase another player's influence, both players' influence increase by an amount, which can be equal for both players. This amount of increase of influence can also be tied to the amount of currency transferred between the players. For example, the amount of increase of influence can be proportional to the amount of currency transferred between the players. In yet further embodiments, players may not spend game currency to increase their own influence during the round of the online game, except by spending game currency to increase another player's influence. For example, players may not spend currency on themselves to increase their own influence.

The online game then updates stored influence amounts of the players based on the received spending information (step 1206). The stored influence amounts and the spending information received from the players can be stored in a database associated with a server providing the online game (e.g., server 114). The database can be local to or remote from the server. The online game can retrieve the stored influence amounts and the received spending information from the database. After retrieving the information from the database, the online game can then update the stored influence amounts of the players based on the received spending information. The update can include performing computations using, for example, one or more processors and at least one memory for storing program instructions in the server.

The online game can display the updated stored influence amounts of the players to the players of the online game (step 1208). The online game can provide a visual display of the change in the stored influence amounts of the players after the update. For example, in some embodiments, the online game can provide a quantitative display of the stored influence amounts of the players using speech balloons associated with the players. In these embodiments, changes in the stored influence amounts of the players after the update are reflected by corresponding changes in the sizes of the speech balloons. In some embodiments, the online game can display the updated stored influence amounts of the players in real-time.

Steps 1204, 1206, and 1208 can occur for one or several iterations.

At the end of the round, which can occur based on a predetermined duration or after meeting a revenue target, the online game evaluates the stored influence amounts of all players, and selects one or more players based on their stored influence amounts (step 1210). In some embodiments, a plurality of players can be selected for moving on to a subsequent round (e.g., Finalist Round 204). In some embodiments, the online game can select the player with the most influence as a winner of the online game.

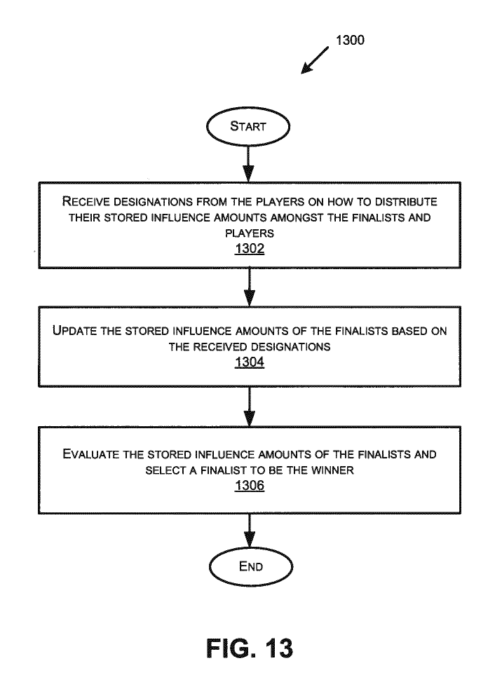

FIG. 13 is a flow chart illustrating an exemplary method 1300 for a round (e.g., Finalist Round 204) of an online game in accordance with some embodiments. It will be readily appreciated by one of ordinary skill in the art that the illustrated procedure can be altered to delete steps or further include additional steps.

The online game can select a plurality of players from a previous round (e.g. described with reference to FIG. 12) to enter the round illustrated in FIG. 13 as finalists, based on the players' stored influence from the previous round. The remaining players not selected as finalists continue to join the round of FIG. 13 as players.

Referring to FIG. 13, the online game receives designations from the players on how to distribute the players' stored influence amounts amongst the finalists and players (step 1302). The designations can include the players' votes for the finalists. In some embodiments, after the players have voted for the finalists, the players can distribute their stored influence amounts to the finalists by lending their stored influence amounts to the finalists. In some embodiments, the players can lend their influence which had been carried over from a previous round (e.g. Accruing Round 202). For example, if a player has 3,000 influence from the previous round, the player can choose which finalist the player wants to lend his or her influence to. In addition, the player may choose to lend some or all of his or her influence to a finalist.

In some embodiments, a player's lending of influence to a finalist does not deplete the influence of the lending player and would allow the player to give (or receive) influence to (or from) other players. The amount in which their influence increases during this time equally increases their “influence commitment” to the finalist of their choice. In this way, even though a player cannot switch finalist after he or she has voted for a finalist, the online game allows the player the ability to change the outcome of the round in step 1302.

It is further appreciated that one or more of the following embodiments relating to the finalists' stored influence amounts is possible, prior to the online game receiving designations from the players on how to distribute their stored influence amounts. For example, in some embodiments, the online game can equalize the finalists' influence at the start of the round of FIG. 13. In other embodiments, the online game can maintain the finalists' level of influence from a previous round (e.g. Accruing Round 202) going into the round of FIG. 13. In some further embodiments, the online game can give the finalists a set amount of influence in the round of FIG. 13 based on the finalists' performance in a previous round. For example, the online game can provide, in the round of FIG. 13, a finalist having the most influence at the end of the previous round a highest amount of influence (e.g., 5,000 influence points), while providing a finalist having the least influence at the end of the previous round a lowest amount of influence (e.g., 4,000 influence points).

In some embodiments, a player's selection of a finalist can affect how much currency the player receives in a future game. For example, if a player selects the winning finalist in a game by lending the finalist all of his or her influence, the online game provides an amount of game currency to the player in a subsequent game, the amount of provided game currency corresponding to the amount of influence the player lent to the winning finalist.

In some other embodiments, the online game allows players to lend their influence to more than one finalist. Here, instead of lending/giving the influence to only one of a plurality of finalists, the players can apportion their influence across a number of the finalists in order to “hedge” their selections.

The online game then updates the stored influence amounts of the finalists based on the designations received from the players (step 1304). The stored influence amounts and the spending information received from the players can be stored in a database associated with a server providing the online game (e.g., server 114) and updated by performing computations using the processor(s) and memory in the server, as described previously with reference to FIG. 12.

At the end of the round of FIG. 13, which can occur based on a predetermined duration or after meeting a revenue target, the online game evaluates the stored influence amounts of the finalists, and selects a finalist to be the winner (step 1306). In some embodiments, the finalist with the highest stored influence amount is selected to be the winner of the round. The online game can award a prize to the winner, which may be in the form of a cash prize, or a right to spend a cash prize. In some other embodiments, the winner may have to go through another round (e.g., Impact Round 206) before a prize is awarded. In some embodiments, the online game can select the player with the most influence as a winner of the online game.

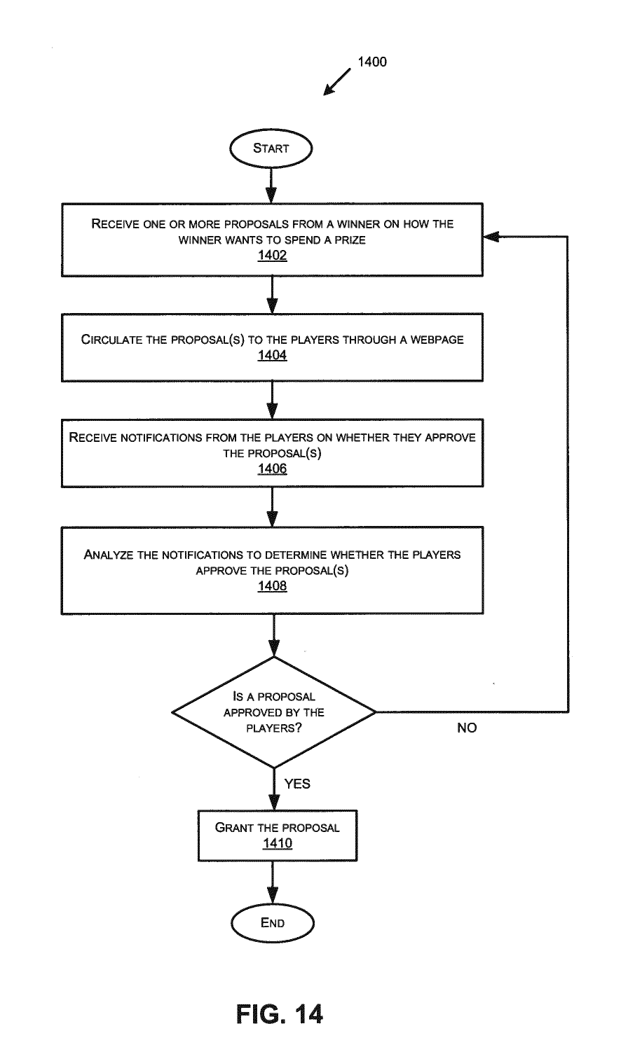

FIG. 14 is a flow chart illustrating an exemplary method 1400 for a round (e.g., Impact Round 206) of the online game in accordance with some embodiments. It will be readily appreciated by one of ordinary skill in the art that the illustrated procedure can be altered to delete steps or further include additional steps.

The online game can select a winner from a previous round (e.g., a single winner from Accruing Round 202 or the winning Finalist from Finalist Round 204) to enter the round illustrated in FIG. 14. The remaining players can continue to join the round of FIG. 14.

Referring to FIG. 14, the online game receives one or more proposals from the winner from a previous round (e.g. Finalist Round 204) on how to spend a prize that may be in the form of a cash prize (step 1402). For example, the online game can receive a first proposal and a second proposal from the winner on how to spend the case prize.

In some embodiments, the winner can present a number of proposals that can be assigned to brackets (similar to, for example, an NCAA™ bracket). For example, the online game can receive four different proposals (proposals A, B, C, D) from the winner. The online game allows the crowd to choose the winning proposals of proposal A versus proposal B and of proposal C versus proposal D to move on to a next winning proposal round where the crowd will determine which one of these two proposals is the approved proposal. For example, as described in further detail in the following embodiments, the online game can allow the crowd to choose the proposals by voting for the proposal of their choice to indicate whether they agree with or disagree with the proposal.

In some embodiments, a proposal can, for example, be in the form of a video posted by the winner indicating how he or she wants to spend the prize. In some embodiments, the online game allocates a prescribed amount of time to the round of FIG. 14, during which the winner seeks the other players' approvals on his or her proposal(s).

Next, the online game circulates the proposal(s) to the players through a webpage (step 1404). The webpage can be hosted on a server providing the online game (e.g., server 114). The online game can circulate the proposal(s) through other means, such as emails, text or multi-media messages, newsfeeds, and any other media.

The online game then receives notifications from the players on whether they approve the winner's proposal(s) on how to spend the cash prize (step 1406). The notifications can include information relating to the proposal(s) the players have selected. The notifications can further include the players' votes for each proposal(s). In some embodiments, the online game receives notifications from the players on whether they agree with or disagree with the winner's proposal on how to spend the cash prize.

In some other embodiments, where there are two winner proposals being presented, the online game receives notifications from the players on whether the players approve of one of the first and second proposals over the other proposal.

In some embodiments, the players can vote to approve one or more of the proposals, or the players may vote on none of the proposals. For example, the players can vote to approve a first proposal, or vote to approve a second proposal, or choose not to vote for either proposal. Therefore, the online game can receive more than one notification from a player in some instances, or no notification in other instances.

In some embodiments, the online game carries over the players' influence from a previous round into the round of FIG. 14. In these embodiments, the online game weighs the decision of each player to approve the proposal based on the player's influence. For example, after the online game receives an approval from a player regarding the proposal(s), the online game aligns the amount of that player's influence to the proposal(s). Likewise, after the online game receives a rejection from a player, the online game aligns the amount of that player's influence against the proposal(s). In some other embodiments, instead of using influence to determine whether the proposal(s) passes, the online game can tally votes from the players, wherein each player has a single vote. It is readily appreciated, however, that the online game can weigh the players' votes using means associated with previous rounds, or weigh the votes using other means.

In some embodiments, the online game can weigh the players' votes based on the players' influence in a concurrent or subsequent round(s) of another game(s). For example, a player can participate in an accruing round of another game while the player is still in an impact round of a game. If the player's influence in the accruing round of the other game increases, the online game provides a corresponding increase in the weight of the player's vote for the winner's proposal in the impact round of the game. If a player takes part in multiple concurrent accruing rounds of other games, the online game aggregates the player's increase in influence from those multiple concurrent accruing rounds, and provides a corresponding increase in weight of the player's vote for the winner's proposal in the impact round of the game. Therefore, in some embodiments, the online game allows players to affect the outcome of an impact round of a game by taking part in the accruing rounds of other games.

At the end of the allotted time for the proposal, the online game can analyze the players' notifications to determine which proposals the players selected, and whether the proposal(s) is or are approved (step 1408). For example, the online game can tally whether the aligned influence outweighs the against influence. After the determination, the online game can announce to the players the outcome of the proposal(s), based on the amount of influence aligned to the proposal(s). The winner will then know whether and which of his or her proposal(s) has gained the approval of the players. In some embodiments, the online game determines the approval of the players based on the proposal obtaining a majority of the players' influence or single votes, which can be a number or percentage.

In some embodiments, where there are two proposals presented, the online game can analyze the notifications to determine which of the first and second proposals is selected by the players, wherein the selected proposal is provided to the winner.

In some other embodiments, where the winner has presented a number of proposals assigned to brackets (e.g. four different proposals: proposals A, B, C, D), the online game can analyze the notifications to determine which of the winning proposals of proposal A versus proposal B and of proposal C versus proposal D move on to a next winning proposal round where the crowd will determine which one of these two proposals is the approved proposal.

After the online game determines that the proposal has been approved by the players, the online game grants the winner his or her proposal (step 1410).

In some embodiments, if the winner's proposal(s) is/are rejected by the players, the online game provides the winner an opportunity to submit another proposal to the players (returning to step 1402). Once again, the players can choose to accept the new proposal within an allotted time in the round.

At the end of the round of FIG. 14, if the winner's proposal wins the players' approval, the online game grants the winner the right to spend the prize in accordance with the approved proposal. The online game can forfeit any unallocated or unspent portion of the prize. In some embodiments, the winner's expenditures can be recorded by a film crew and the online game can circulate the recording through a webpage or any other media.

Throughout the online game, player activities can be supported by a combination of game graphics and user-generated, real-world video content. The game graphics can be used to graphically depict influence status across players, while user-generated content can be used to introduce the finalists or communicate winner's proposals and prize allocations in the real world.

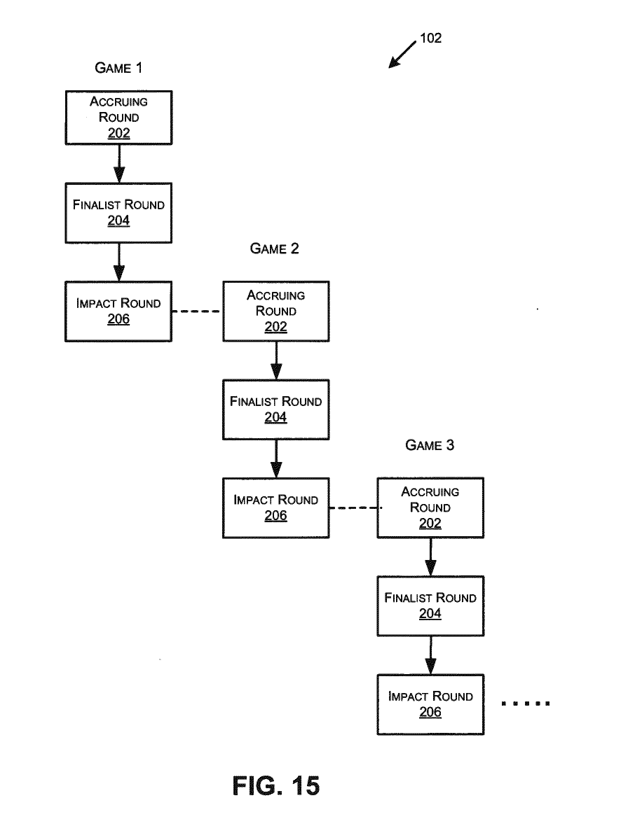

FIG. 15 is a flow chart illustrating an exemplary sequence of rounds for online game 102 of FIG. 1. For example, as shown in FIG. 15, online game 102 can comprise a plurality of games, such as Game 1, Game 2, Game 3, and so forth. It is understood that online game 102 can comprise any number of games, and that each game can further comprise an Accruing Round 202, a Finalist Round 204, and an Impact Round 206, as described previously with reference to FIG. 2.

In some embodiments, online game 102 of FIG. 15 is played continuously from one game to a next game. For example, Accruing Round 202 of Game 2 can begin when Impact Round 206 of Game 1 commences or ends. In some embodiments, players from Impact Round 206 of Game 1 can continue to play in Accruing Round 202 of Game 2. In some further embodiments, players can carry over any game currency and/or influence remaining from one game to a next game.

In some embodiments, online game 102 of FIG. 15 can have a time duration which is pre-determined. In some other embodiments, the time duration of online game 102 in the example of FIG. 15 can be dynamic, which can depend on feedback and responses of the players during each game, or depend on online game 102 reaching a target revenue per game.

It is understood that the above-described exemplary embodiments are for illustrative purposes only and are not restrictive of the claimed subject matter. Certain parts of the game can be deleted, combined, or rearranged, and additional parts can be added to the game. It will, however, be evident that various modifications and changes may be made without departing from the broader spirit and scope of the claimed subject matter as set forth in the claims that follow. The specification and drawings are accordingly to be regarded as illustrative rather than restrictive. Other embodiments of the claimed subject matter may be apparent to those skilled in the art from consideration of the specification and practice of the claimed subject matter disclosed herein.

What is claimed is:

1. A method comprising:
providing currency to a plurality of players for an online game having a duration;
receiving spending information from a first player of the plurality of players, wherein the spending information affects an influence amount of a second player of the plurality of players; and
updating a stored influence amount of the second player based on the received spending information, wherein, at the end of the duration, a stored influence amount of the second player is evaluated to determine whether the second player has one of the top stored influence amounts, and wherein the players amongst the plurality of players having the top stored influence amounts compete to potentially win a prize.

2. The method of claim 1, wherein the duration is a predetermined duration for an accruing round of the online game.

3. The method of claim 1, wherein the duration is a dynamic duration for an accruing round of the online game.

4. The method of claim 1, wherein the influence amount of the second player increases after the first player spends currency on the second player.

5. The method of claim 1, wherein the spending information of the first player affects an influence amount of the first player.

6. The method of claim 5, wherein the influence amount of the first player increases after the first player spends currency on the second player.

7. A method for an online game having a plurality of players, each having a stored influence amount, the method comprising:
receiving designations from the plurality of players on how to distribute their stored influence amounts amongst finalists of the online game having a duration;
updating the stored amounts of the finalists based on the received designations; and
at the end of the duration, evaluating the stored amounts of the finalists to determine which of the finalists is the winner.

8. The method of claim 7, wherein the duration is a predetermined duration for a finalist round of the online game.

9. The method of claim 7, wherein the duration is a dynamic duration for a finalist round of the online game.

10. The method of claim 7, wherein updating the stored amounts of the finalists comprises compositing the distributed influence amounts designated for each finalist.

11. The method of claim 7, wherein the designations from the plurality of players on how to distribute their stored influence amounts affect the stored amounts of the finalists.

12. The method of claim 7, wherein the designations from the plurality of players on how to distribute their stored influence amounts do not affect the players' stored influence amounts.

13. The method of claim 7, further comprising receiving one designation for one finalist from each player.

14. The method of claim 7, further comprising receiving designations for more than one finalist from each player.

15. The method of claim 7, further comprising:
receiving spending information from a first player of the plurality of players, wherein the spending information affects an influence amount of a second player of the plurality of players; and
updating a stored influence amount of the second player based on the received spending information.

16. The method of claim 15, wherein the spending information from the first player and the updated stored influence amount of the second player affect the stored amounts of the finalists.

17. A method for an online game having a winner amongst a plurality of players, the method comprising:
receiving a proposal from the winner on how to spend a cash prize;
circulating the proposal to the plurality of players through a webpage;
receiving notifications from players of the plurality of players on whether they approve the proposal on how to spend the cash prize; and
analyzing the notifications to determine whether the players approve the proposal.

18. The method of claim 17, further comprising:
receiving notifications from players of the plurality of players on whether they agree with or disagree with the proposal on how to spend the cash prize.

19. The method of claim 18, further comprising:
granting the proposal if the players accept the proposal.

20. The method of claim 18, further comprising:
if the proposal is not accepted by the players:
receiving a next proposal from the winner on how to spend the cash prize.

21. The method of claim 17, wherein receiving a proposal from the winner on how to spend a cash prize includes receiving a first proposal and a second proposal from the winner on how to spend the case prize.

22. The method of claim 21, further comprising:
receiving notifications from players of the plurality of players, wherein these notifications indicate that the players approve of one of the first and second proposals over the other proposal; and
analyzing the notifications to determine which of the first and second proposals is selected by the players of the plurality of players, wherein the selected proposal is provided to the winner.

23. An online game stored on one or more non-transitory computer-readable mediums having instructions, that when executed, cause a processor to provide
the online game, the online game comprising:
a first round having a first duration, the first round configured to:
provide currency to a plurality of players,
receive information from the plurality of players on how to spend the currency on other players in the online game, and
updating the stored influence amounts of the plurality of players based on the received information, wherein, at the end of the first duration, the stored influence amounts are evaluated to determine which players of the plurality of players are considered to be finalists and which players are to be considered a crowd;
a second round having a second duration, the second round configured to:
receive designations from the crowd on how to distribute their stored influence amounts amongst the finalists,
update the stored amounts of the finalists based on the received designations, and
at the end of the second duration, evaluating the stored amounts of the finalists to determine which of the finalists of a winner;
a third round of the online game configured to:
receive a proposal from the winner on how to spend a cash prize,
circulate the proposal to the plurality of players through a webpage,
receive notifications from the players on whether they approve the proposal on how to spend the cash prize, and
analyze the notifications to determine whether the plurality of players approve the proposal.
